(19) United States
(12) Patent Application Publication
(10) Pub. No.: US 2007/0002127 A1
(43) Pub. Date: Jan. 4, 2007

(54) Mobile phone having an image capture device

(75) Inventors: Bin Yang, Shanghai City (CN); David Ho, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/156,723

(22) Filed: Jun. 21, 2005

(51) Int. Cl. H04N 7/14

(52) U.S. Cl. 348/14.01

(57) ABSTRACT

A mobile phone includes an image capture device; a communication module for connecting to a distal sever via a base station system, the server transmitting a specific piece of the geographic information to the mobile phone via the base station system after identifying a location of the communication module; and a data-combining module for combining an image captured by the image capture device and the specific piece of the geographic information within the mobile phone such that when the image is printed in a photo format, the photo includes the specific piece of the geographic information.

### FIELD OF THE INVENTION

The invention relates to a mobile phone, more particularly to a mobile phone having an image capture device.

### BACKGROUND OF THE INVENTION

A mobile phone is very common in our daily life to facilitate a busy person of nowadays to accomplish some of his daily works, like noting down the business appointments, tracking the lists of stocks, making simple calculation, storing addresses of the clients, and transmitting e-mails. A mobile phone of lately is provided with an image acquisition device (such as CMOS and CCD) that can capture image digitally (i.e. converting light into electric charge and process it into electronic images).

One drawback of the aforesaid mobile phone resides in that only the day, month and the year can be formatted into the image so that when the image is printed out in photo format, the photo includes the date displayed thereon. Under such condition, the user (the main character of the photo) may forget after a long period of time where the photo was taken due to lack of the geographical information.

### SUMMARY OF THE INVENTION

The object of the present invention is to provide a mobile phone including an image capture device having the ability to display the geographical information of the photo once the former is printed out from the image acquisition device. The user can easily remember the environment of the photo-taking location.

A mobile phone is provided according to the present invention for use in a radio telecommunication system. The radio telecommunication system includes at least one base station system and a sever controlling the communication in the base station system, wherein a pluralities of geographic information are stored within the server. The mobile phone includes an image capture device; a communication module for connecting to the sever via the base station system, the server transmitting a specific piece of the geographic information to the mobile phone via the base station system after identifying a location of the communication module; and a data-combining module for combining an image captured by the image capture device and the specific piece of the geographic information within the mobile phone such that when the image is printed in a photo format, the photo includes the specific piece of the geographic information.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a mobile phone of the present invention shown together with a radio telecommunication system;

FIG. 2 shows the mobile phone of the present invention, illustrating how it is communicated to a base station and a server; and

FIG. 3 shows a photo taken by an image acquisition device employed within the mobile phone of the present invention.

### DETAILED DESCRIPTIONS OF THE PREFERRED EMBODIMENT

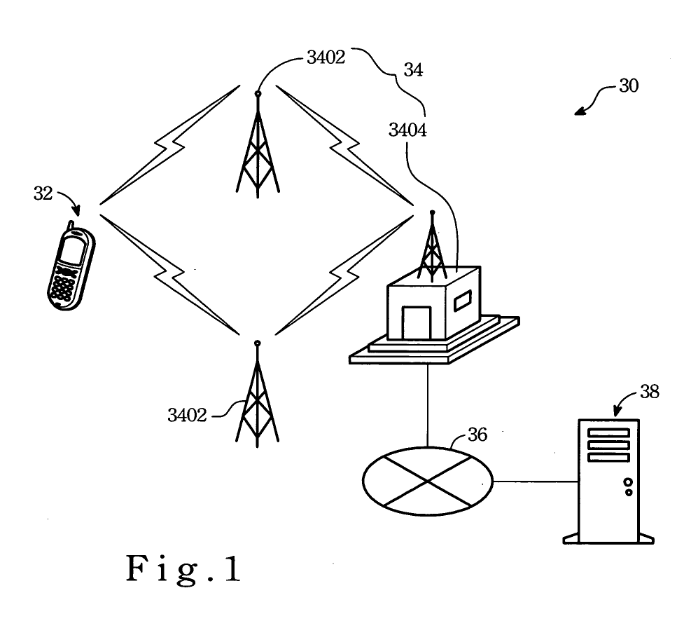

Referring to FIG. 1, a mobile phone 32 according to the present invention is used in a radio telecommunication system 30. The radio telecommunication system 30 includes a base station system 34 consisting of a base station 3404, and a plurality of cell towers 3402 via which the mobile phone 32 is communicated with the base station 3404. The server 38 is communicated to the base station 3404 via a network 36 (such as the Internet).

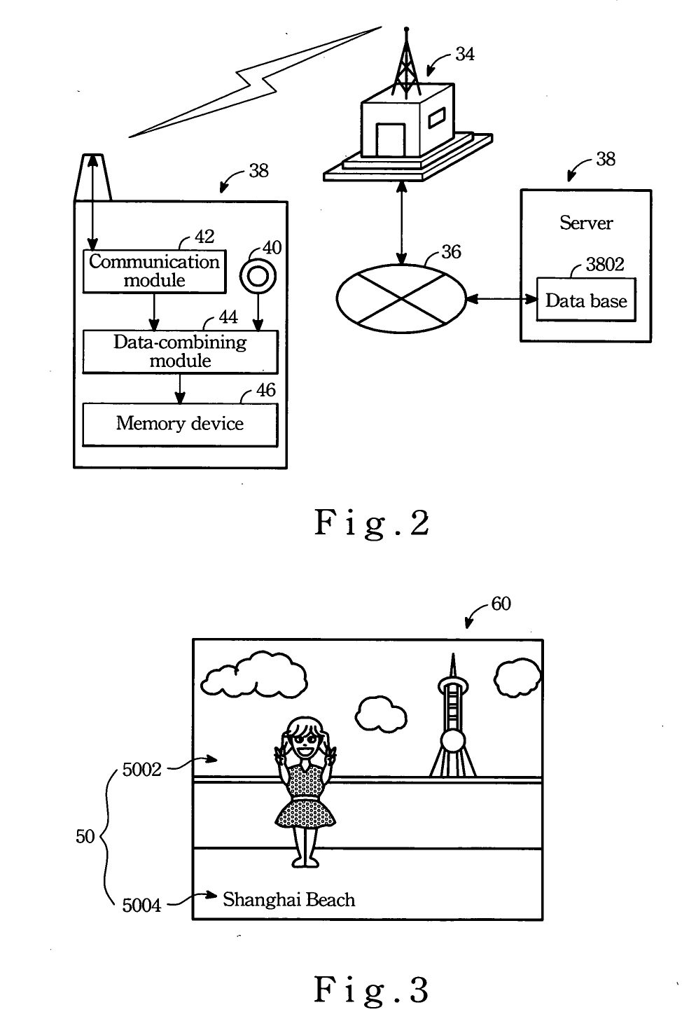

Referring to FIG. 2, the server 38 has a data base 3802 stored with a plurality pieces of geographic information in advance. The geographic information includes names of places, short introduction to history, population and interesting events of the places and geographical location thereof. The mobile phone 32 of the present invention includes an image capture device 40, a communication module 42, a memory device 46 and a data-combining module 44.

The image capture device 40 can capture images 5002 (see FIG. 3), and later stores the electronic images digitally therein, such as image files. The images can be a landscape, scenery, persons or building. The communication module 42 can be connected to a distal sever 38 via an adjacent base station 34. The adjacent base station 34 transmits a position signal to the distal server 38 after identifying a location of the communication module 42 so as to permit the distal server 38 to conduct a comparing operation of the location of the communication module 42 relative to any piece of the geographic information stored with the data base 3802 in the server 38. Preferably, the location of the communication module 42 is referred by a combination of global latitude and longitude of the mobile phone 32. In the mobile phone 32 of the present invention, TOA (time of arrival) technology or E-OTD (Enhanced Observation Time Difference) technology or A-GPS (Assisted Global Positioning System) technology is used to generate the location of the communication module 42. The distal server 38 transmits a specific piece of the geographic information 5004 (see FIG. 3) to the mobile phone 32 via the adjacent base station 34 once coincidence occurs between the location of the communication module 42 and the specific piece of the geographic information 5004.

The data-combining module 44 combines the image 5002 and the specific piece of the geographic information 5004 within the mobile phone 32. The mobile phone 32 further includes a display, such as an LCD (not shown), for displaying a combination of the image 5002 and the specific piece of the geographic information 5004 such that the image can be printed in a photo format 50. The photo 60 includes the image 5002 and the specific piece of the geographic information 5004, as best shown in FIG. 3.

An important to note is that after capturing an image by using the image capture device 40 employed in the mobile phone 32, the latter transmits an e-mail to the adjacent base station 34, informing whereabouts of the mobile phone 32 relative to the adjacent base station 34. The e-mail includes an initializing command that is transmitted by the adjacent base station 34 to the server 38 via the network 36 so as to permit the server 38 to conduct the comparing operation. A second aspect to note that the image capture device 40 further includes a plurality sets of digital reference numbers which are stored within the memory device 46 of the present mobile phone 32 and which are concerned with the existing location of the communication module 42. The location of the communication module 42 is generated based on the digital reference numbers.

Since each of the photo taken by the mobile phone 32 of the present invention includes a piece of geographic information, the viewer (if he is one character of the photo) of the photo can easily reminisce where and when the photo was taken, thereby satisfying an inquisitive mind of the viewing person.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mobile phone for use in a radio telecommunication system, the radio telecommunication system including at least one base station system and a sever controlling the communication in the base station system, wherein a plurality of geographic information are stored within the server, the mobile phone comprising
an image capture device;
a communication module for connecting to the sever via the base station system, the server transmitting a specific piece of the geographic information to the mobile phone via the base station after identifying a location of said communication module; and
a data-combining module for combining an image captured by said image capture device and said specific piece of the geographic information within the mobile phone such that when said image is printed in a photo format, said photo includes said specific piece of the geographic information.

2. The mobile phone according to claim 1, wherein said communication module transmits a positioning signal to the server via the base station system, after receipt of said positioning signal the server conducting a comparing operation of said location of said communication module relative to any piece of the stored geographic information such that the server transmits said specific piece of the geographic information to said communication module once coincidence occurs between said location of said communication module and said specific piece of the geographic information.

3. The mobile phone according to claim 1, wherein the mobile phone transmits an e-mail to the base station system, said e-mail including an initializing command that is transmitted by the base station system to the server so as to permit conduction of said comparing operation.

4. The mobile phone according to claim 1, wherein said location of said communication module is referred by a combination of global latitude and longitude of the mobile phone.

5. The mobile phone according to claim 1, wherein the radio telecommunication system further includes a network, the base station system being communicated to the server via said network.

6. The mobile phone according to claim 1, further comprising a display for showing a combination of said image and said specific piece of the geographic information.

7. The mobile phone according to claim 1, wherein TOA (time of arrival) technology is used to generate said location of said communication module.

8. The mobile phone according to claim 1, wherein E-OTD (Enhanced Observation Time Difference) technology is used to generate said location of said communication module.

9. The mobile phone according to claim 1, wherein A-GPS (Assisted Global Positioning System) technology is used to generate said location of said communication module.

10. The mobile phone according to claim 1, wherein said image is captured digitally, said image capture device further including digital reference numbers, said location of said communication module being generated based on said digital reference numbers.

11. The mobile phone according to claim 10, further comprising a memory device, said digital reference numbers being recorded within said memory device.
